(19) United States
(12) Patent Application Publication
(10) Pub. No.: US 2011/0234475 A1
(43) Pub. Date: Sep. 29, 2011

(54) HEAD-MOUNTED DISPLAY DEVICE

(76) Inventor: Hiroshi ENDO, Saitama (JP)

(21) Appl. No.: 13/016,427

(22) Filed: Jan. 28, 2011

(30) Foreign Application Priority Data
Mar. 25, 2010 (JP) 2010-070053

(51) Int. Cl. G09G 5/00

(52) U.S. Cl. 345/8

(57) ABSTRACT

A head-mounted display device captures an image of a real space as an external video through a circular fish-eye lens. A main image is extracted from a central portion of the external video, and a left image, a right image, an upper image, and a lower image are extracted as sub-images from the periphery of the external video. The distortion of a wide-angle lens is corrected in the main image, and the main image is displayed at the center. Each sub-image is displayed around the main image.

### BACKGROUND OF THE INVENTION

1. Field of the Invention

The present invention relates to a head-mounted display device that is worn on a head of a wearer such that the wearer can view an image.

2. Description of the Related Art

A head-mounted display device (hereinafter, referred to as an HMD) is known which is worn on a head of a wearer and displays a video in front of eyes of the wearer. The HMD is used for various purposes. One of the purposes of the HMD is to display various kinds of additional information (hereinafter, referred to as AR information) superimposed on a real space (external scene), thereby providing information. For example, a light transmissive HMD and a video see-through HMD are used for the purpose. In the light transmissive HMD, the real space and the AR information displayed on liquid crystal are superimposed by, for example, a half mirror such that they can be observed by the user. In the video see-through HMD, a video camera captures the image of real space from the viewpoint of the user, and an external video obtained by the image capture is composed with the AR information such that the user can observe the composed information.

In the video see-through HMD, since the visual field that can be observed by the wearer is limited by the angle of view of the video camera, the visual field is generally narrower than that in a non-mounted state. Therefore, when the wearer moves with the HMD worn on the head, the wearer is likely to contact the surroundings, particularly, an obstacle disposed in the left-right direction deviating from the visual field due to the influence of the limit of the visual field.

An HMD is known which includes a detecting sensor that measures a distance between an image output unit provided in front of eyes and an external obstacle. In the HMD, when the obstacle comes close to the distance where it is likely to contact the image output unit, an arm holding the image output unit is moved backward to avoid contact with the obstacle on the basis of the detection result of the detecting sensor (see JP-A-2004-233948).

However, in JP-A-2004-233948 in which a portion of the HMD is moved, in many cases, it is difficult to avoid the obstacle, and the wearer needs to move in order to avoid the obstacle. Therefore, it is preferable to ensure a wide visual field even when the video see-through HMD is worn. It is considered that a wide-angle lens which has a short focal length and is capable of capturing an image in a wide range is used to capture the image of the real space in order to widen the visual field. However, in the wide-angle lens, there is a large distortion in a captured image. Therefore, when the wide-angle lens is used, it is possible to provide a wide visual field to the wearer, but the real space observed by the wearer is distorted, which hinders the actions of the wearer.

### SUMMARY OF THE INVENTION

The present invention has been made in view of the above-mentioned problems and an object of the present invention is to provide a head-mounted display device that enables a user to freely move while ensuring a wide visual field.

According to a first aspect of the invention, a head-mounted display device includes: an imaging unit capturing an image of a real space as an external video through a wide-angle lens from a viewpoint substantially the same as that of the wearer; an image dividing unit extracting a portion of the external video as a main image and extracting the external video around the main image or a peripheral image of the external video as a sub-image; a distortion correcting unit correcting distortion of the wide-angle lens for the main image; and a display unit displaying the main image in front of eyes of the wearer and displaying the sub-image around the main image.

According to a second aspect of the invention, in the head-mounted display device, the image dividing unit may extract the sub-image from the external video so as to overlap a portion of the main image.

According to a third aspect of the invention, in the head-mounted display device, the image dividing unit may extract the sub-images from left and right sides of the main image, or from left and right peripheral portions of the external video, and the display unit may display the corresponding sub-images on the left and right sides of the main image.

According to a fourth aspect of the invention, in the head-mounted display device, the image dividing unit may extract the sub-images from upper, lower, left, and right sides of the main image, or from upper, lower, left, and right peripheral portions of the external video, and the display unit may display the corresponding sub-images on the upper, lower, left, and right sides of the main image.

According to a fifth aspect of the invention, the head-mounted display device may further include: a motion detecting unit detecting motion of a head of the wearer; and a range adjusting unit changing a size of a range of the real space displayed by the main image on the basis of the detection result of the motion detecting unit.

According to a sixth aspect of the invention, in the head-mounted display device, when the motion detecting unit detects the motion, the range adjusting unit may change the range of the real space displayed by the main image to be wider than that when the motion detecting unit does not detect the motion.

According to a seventh aspect of the invention, in the head-mounted display device, when the speed of the motion detected by the motion detecting unit is equal to or more than a predetermined value, the range adjusting unit may change the range of the real space displayed by the main image to be wider than that when the speed of the motion is less than the predetermined value.

According to an eighth aspect of the invention, in the head-mounted display device, the image dividing unit may extract a central portion of the external video as the main image such that a center of the main image is aligned with a center of the external video captured by the imaging unit.

According to a ninth aspect of the invention, the head-mounted display device may further include: a viewpoint detecting unit detecting the viewpoint position of the wearer on the main image or the sub-image; and a center control unit detecting a gaze position of the wearer on the external video on the basis of the detection result of the viewpoint detecting unit and controlling the image dividing unit to extract the main image having the detected gaze position as its center.

According to a tenth aspect of the invention, in the head-mounted display device, the distortion correcting unit may correct the distortion of the wide-angle lens for the external video, and the image dividing unit may extract the main image from the external video whose distortion is corrected by the distortion correcting unit.

According to an eleventh aspect of the invention, in the head-mounted display device, the imaging unit may include a circular fish-eye lens as the wide-angle lens.

According to a twelfth aspect of the invention, the head-mounted display device may further include an additional information composition unit superimposing additional information on the main image or the sub-image to display the main image or the sub-image having the additional information superimposed thereon.

According to the above-mentioned aspects of the invention, the image of a real space is captured as an external video through a wide-angle lens. A main image and a peripheral sub-image of the main image are extracted from the external video. The distortion of the wide-angle lens is corrected in the main image, and the main image is displayed. In addition, the sub-image is displayed around the main image. In this way, the wearer can freely move while observing the main image and also can obtain a peripheral visual field by the sub-image. Therefore, it is possible for the wearer to easily prevent contact with an obstacle.

### BRIEF DESCRIPTION OF THE DRAWINGS

FIG. 1 is a perspective view illustrating the outward structure of an HMD according to an embodiment of the invention;

FIG. 2 is a block diagram illustrating the structure of the HMD;

FIG. 3 is a block diagram illustrating the structure of an image processing unit;

FIGS. 4A to 4D are diagrams illustrating the generation of a main image and each sub-image from an external video;

FIGS. 5A and 5B are diagrams illustrating an example of the display of the main image and the sub-images;

FIG. 6 is a block diagram illustrating an image processing unit that changes the range of a real space displayed by the main image according to the motion of a wearer;

FIG. 7 is a flowchart illustrating the outline of a control process when the range of the real space displayed by the main image is changed according to the motion of the wearer;

FIGS. 8A and 8B are diagrams illustrating an example of the display of the main image and the sub-images in a wide angle mode and a standard mode;

FIG. 9 is a block diagram illustrating an image processing unit that changes the display range of the main image according to a gaze position;

FIG. 10 is a flowchart illustrating the outline of a control process when the display range of the main image is changed according to the gaze position; and

FIGS. 11A and 11B are diagrams illustrating an example of the main image and the sub-images in which the display range of the main image is changed.

### DESCRIPTION OF THE PREFERRED EMBODIMENTS

### First Embodiment

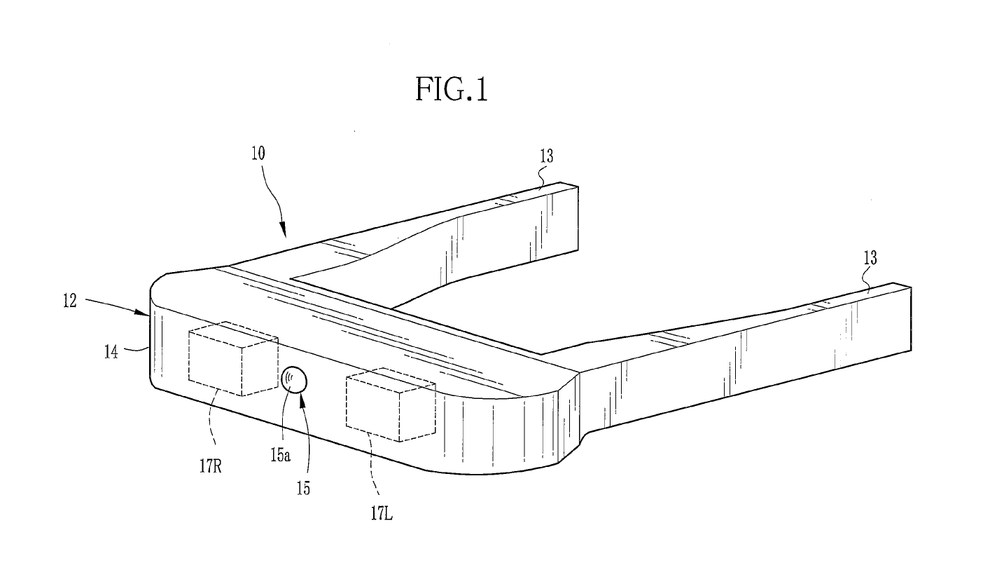

FIG. 1 shows the outward appearance of an HMD (head-mounted display device) according to an embodiment of the invention. An HMD 10 has a goggle shape and includes an anterior eye unit 12 and a pair of temples (bows) 13 that is provided integrally with the anterior eye unit 12. The HMD 10 is worn on the head of the user using the temples 13. The anterior eye unit 12 includes a box-shaped housing 14 that is provided so as to cover the front of the eyes of the wearer, a camera unit 15 having an imaging lens 15a exposed from the front surface of the housing 14, and left and right display units 17L and 17R and various kinds of image processing circuits that are provided in the housing 14.

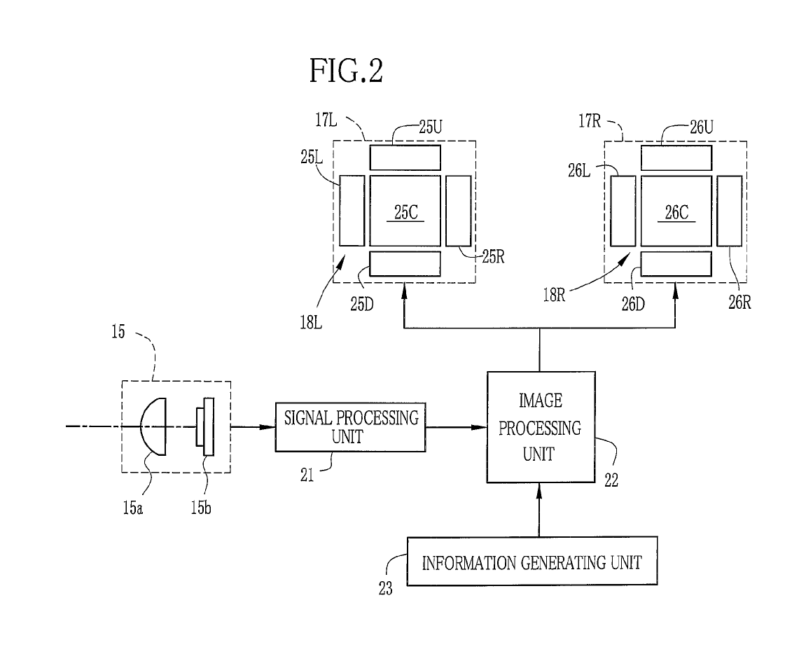

The camera unit 15 captures the image of a real space (external scene) as an external video through the imaging lens 15a. The display units 17L and 17R include, for example, an LCD (liquid crystal display) unit 18L for the left eye, an LCD unit 18R for the right eye (see FIG. 2), and ocular optical systems (not shown), and are provided in front of the corresponding left and right eyes. The wearer observes the images displayed on the LCD units 18L and 18R through the ocular optical systems .

Various kinds of image processing are performed on the external video captured by the camera unit 15, and AR information is superimposed on the processed external video. Then, the external video is displayed on the display units 17L and 17R. In this embodiment, the display units 17L and 17R are provided for each eye. However, a display unit common to the left and right eyes may be provided and the wearer may observe the image on the display unit with both eyes.

As shown in FIG. 2, the camera 15 includes the imaging lens 15a and an image sensor 15b. A wide-angle lens that has a large angle of view and is capable of providing a wide visual field is used as the imaging lens 15a. In this embodiment, a circular fish-eye lens that has an angle of view of about 180° and has an image circle within a light receiving surface of the image sensor 15b is used as the imaging lens 15a.

The image sensor 15b is a CCD type or a MOS type, converts an object image formed by the imaging lens 15a into an electric signal, and outputs the electric signal as an external video. The camera 15 having the above-mentioned structure includes the imaging lens 15a arranged in front of the wearer and captures an image from substantially the same viewpoint as that of the wearer. In this way, the camera 15 captures a circular external video including immediately above, below, and beside the wearer in front of the wearer.

The imaging lens is not limited to the circular fish-eye lens, but a diagonal fish-eye lens or a wide-angle lens with a focal length more than that of the fish-eye lens may be used. In addition, it is preferable that the focal length of the imaging lens be as small as possible in order to provide a wide visual field. For example, the focal length of the imaging lens may be equal to or less than 20 mm. Even when lenses other than the fish-eye lens are used to capture images, a circular external video may be captured such that the image circle is within the light receiving surface of the image sensor 15b. For example, in order to record an object in the real space, a zoom lens may be used as the imaging lens 15a to ensure a focal length required for the recording.

A signal processing unit 21 performs, for example, a noise removing process, a signal amplifying process, and a digital conversion process on the signal output from the camera 15. In addition, the signal processing unit 21 performs various kinds of processes, such as a white balance process, on the digitalized external video. The external video is transmitted from the signal processing unit 21 to an image processing unit 22.

The image processing unit 22 extracts a main image and a sub-image from the external video and performs a process of correcting the distortion of the main image and an AR information composition process, which will be described in detail below. A left image, a right image, an upper image, and a lower image are extracted as the sub-image. The main image and the sub-image are transmitted to each of the display units 17L and 17R.

An information generating unit 23 includes sensors that detect the position or imaging direction (for example, a direction and an angle of elevation) of the camera and generates AR information including, for example, the description of an object in the real space during imaging, on the basis of the detection result of the sensors. The AR information includes composition control information indicating, for example, a position on the image where the AR image will be composed. The AR information is acquired from an external server that stores various kinds of AR information through, for example, a wireless communication unit (not shown). The AR information is transmitted from the information generating unit 23 to the image processing unit 22.

As described above, the left display unit 17L includes the LCD unit 18L and the ocular optical system. The LCD unit 18L includes a main screen 25C, a left screen 25L, a right screen 25R, an upper screen 25U, and a lower screen 25D, which are LCDs. Each of the screens includes a driving circuit (not shown) and displays an image on the basis of input data. The main image is displayed on the main screen 25C, and the left, right, upper, and lower images are displayed on the left screen 25L, the right screen 25R, the upper screen 25U, and the lower screen 25D, respectively.

In the LCD unit 18L, the main screen 25C is provided at the center, and the left screen 25L, the right screen 25R, the upper screen 25U, and the lower screen 25D are provided on the left, right, upper, and lower sides of the main screen 25C, respectively. The wearer views the LCD unit 18L having the above-mentioned structure through the ocular optical system to observe the main image substantially in front of the left eye and observe the left and right images on the left and right sides of the main image. Similarly, the wearer can observe the upper image on the upper side of the main image and the lower image on the lower side of the main image.

The right display unit 17R has the same structure as that of the left display unit 17L and includes the LCD unit 18R and the ocular optical system. The LCD unit 18R includes a main screen 26C, a right screen 26R, a left screen 26L, an upper screen 26U, and a lower screen 26D on which the main image, the left image, the right image, the upper image, and the lower image are displayed, respectively. The image displayed on the LCD unit 18R is observed by the right eye through the ocular optical system.

The observation sizes of the main image, the left image, the right image, the upper image, and the lower image, or the position with respect to the visual field of the wearer are adjusted by, for example, the size or arrangement of each screen of the LCD units 18L and 18R and the magnifying power of the ocular optical system, such that the main image can be clearly observed and the left image, the right image, the upper image, and the lower image cannot be clearly observed, but are substantially observed in the visual field. It is preferable that the observation size or position of the main image be adjusted such that the main image is observed substantially in the same visual field as that in which the person can clearly view the image with one eye. In this embodiment, the visual field in which the main image can be clearly observed is 46 degrees. In addition, the sizes of the screens 25L, 25R, 25U, 25D, 26R, 26L, 26U, and 26D, the positional relationship between the screens and the main screens 25C and 26C, and the ocular optical system are adjusted, such that the left image, the right image, the upper image, and the lower image are observed outside the visual field in which the image can be clearly viewed.

In this embodiment, a plurality of screens are used to display the main image and each sub-image. However, for example, the display surface of one LCD may be divided and the main image and the sub-images may be displayed on the divided display surfaces, such that the wearer can observe the images in the same way as described above.

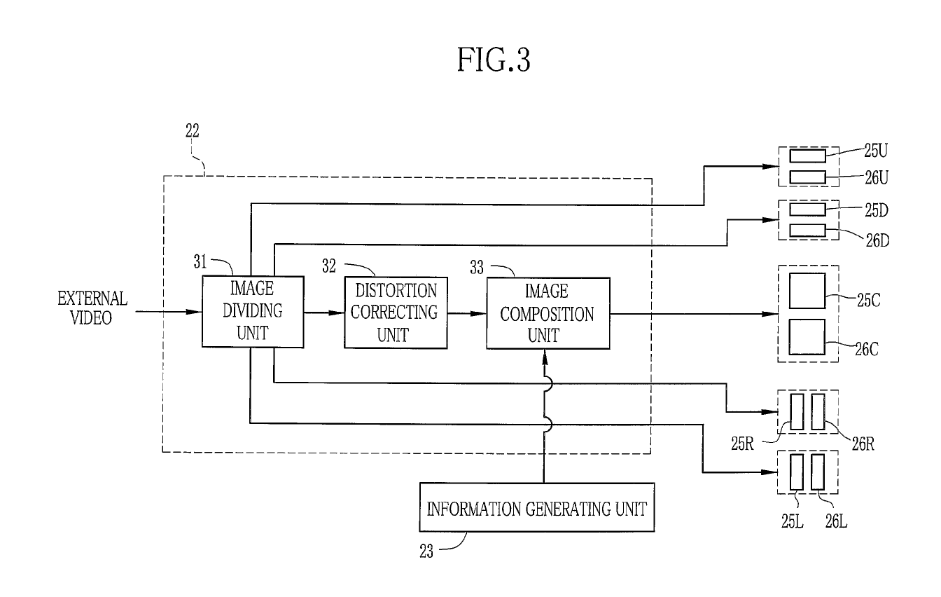

As shown in FIG. 3, the image processing unit 22 includes an image dividing unit 31, a distortion correcting unit 32, and an image composition unit 33. The image dividing unit 31 extracts the main image and the sub-images from the external video. The image dividing unit 31 extracts a central portion of the external video as the main image and extracts peripheral images on the left, right, upper, and lower sides of the external video as the left image, the right image, the upper image, and the lower image. The left image, the right image, the upper image, and the lower image are extracted such that a portion of the range of each of the images overlaps the main image.

The distortion correcting unit 32 receives the main image from the image dividing unit 31. The distortion correcting unit 32 corrects the main image such that the distortion of the imaging lens 15a is removed. Correction parameters for removing the distortion of an image due to the distortion of the imaging lens 15a are set to the distortion correcting unit 32, and the distortion correcting unit 32 uses the correction parameters to correct the distortion of the main image. The correction parameters are predetermined on the basis of, for example, the specifications of the imaging lens 15a.

The correcting process performed on the main image is not performed on each sub-image in order to ensure an image size that is easy to view and ensure a sufficient amount of information regarding the displayed real space while displaying an image on the display screen with a limited size.

The image composition unit 33 receives the main image whose distortion has been corrected by the distortion correcting unit 32 and the AR information from the information generating unit 23. The image composition unit 33 composes the AR information with the main image on the basis of the composition control information included in the AR information to generate a main image on which various kinds of AR information are superimposed.

The main image from the image composition unit 33 is transmitted to the main screens 25C and 26C and is then displayed on the main screens 25C and 26C. The left image extracted by the image dividing unit 31 is transmitted to and displayed on the left screens 25L and 26L, and the right image is transmitted and displayed on the right screens 25R and 26R. The upper image is transmitted and displayed on the upper screens 25U and 26U and the lower image is transmitted and displayed on the lower screens 25D and 26D. In this way, an image in which the left image, the right image, the upper image, and the lower image are arranged on the left, right, upper, and lower sides of the main image is displayed.

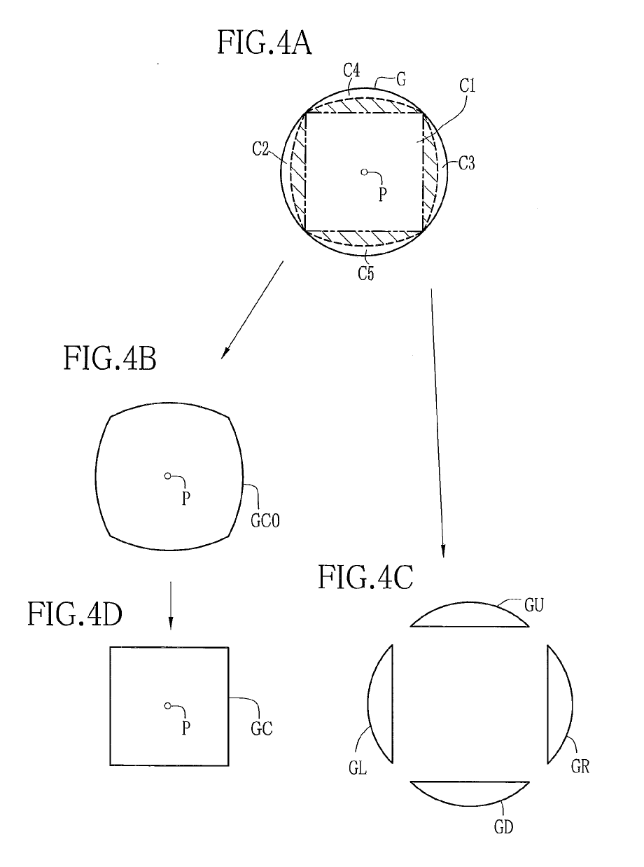

FIGS. 4A to 4B schematically show the generation of the main image and each sub-image from the external video. A captured external video G has a circular shape (FIG. 4A). The image dividing unit 31 extracts a main image GC0 from the external video G (FIG. 4B), and extracts a left image GL, a right image GR, an upper image GU, and a lower image GD from the external video G (FIG. 4C). The main image GC0 is corrected into a rectangular main image GC by the distortion correcting unit 32 (FIG. 4D).

A main image region C1 from which the main image GC0 is extracted is inside a boundary line represented by a dashed line in FIG. 4A. The main image region C1 is arranged such that the center position P thereof is aligned with the center position of the external video G (the position of the optical axis of the imaging lens 15a) , and the center positions of the main image GC0, the corrected main image GC, and the external video G are aligned with each other. The main image region C1 has a barrel shape, which is a rectangle in a swollen shape, and the main image GC corrected by the distortion correcting unit 32 has a rectangular shape.

Sub-image regions C2 to C5 from which each sub-image is extracted are outside a boundary line represented by a two-dot chain line and are provided on the left, right, upper, and lower sides of a peripheral portion of the external video G, respectively. Each of the sub-image regions C2 to C5 is partitioned so as to partially overlap the main image region C1. In FIG. 4A, the overlap portions are hatched. In this way, the relation between an object image in the displayed main image and an object image in each displayed sub-image can be easily grasped. In this embodiment, the sub-image extracted from the peripheral portion of the external video is a sub-image extracted from the periphery of the main image.

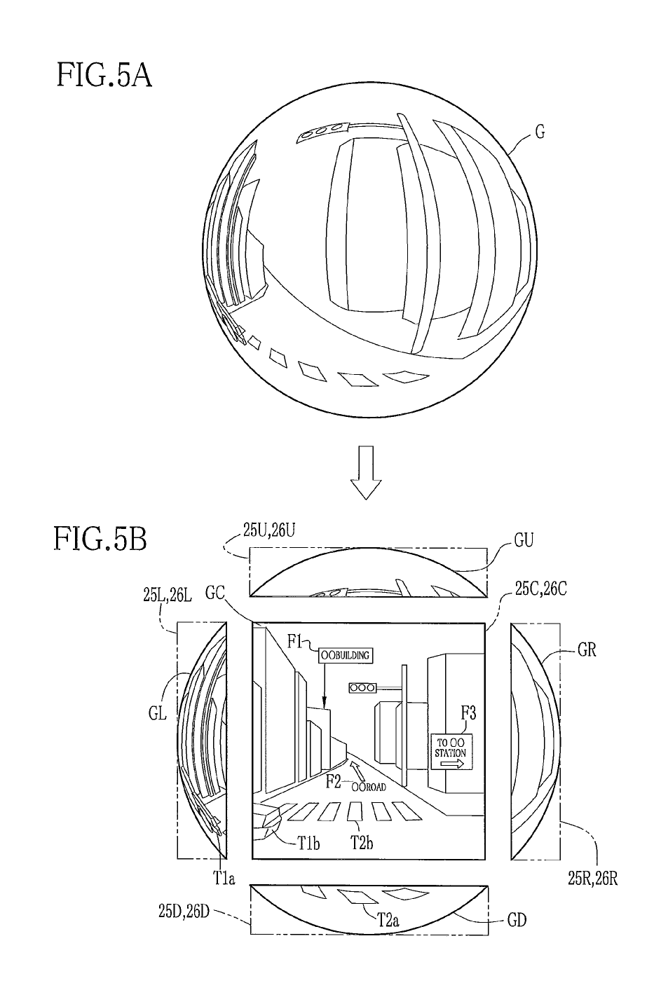

FIGS. 5A and 5B show an example of an image-captured state and a display state. FIG. 5A shows a captured external video and FIG. 5B shows a display state corresponding to the external video. The object image in the circular external video G is distorted due to the distortion of the imaging lens 15a. The main image GC that has been extracted from the central portion of the external video G is displayed on the main screens 25C and 26C. The distortion of the main image GC is corrected and then the main image GC is displayed. In addition, for example, AR information F1 indicating the name of a building, AR information F2 indicating the name of a road, and AR information F3 indicating the direction of an adjacent station are composed and displayed.

The left image GL, the right image GR, the upper image GU, and the lower image GD extracted from the peripheral portion of the external video G are displayed on the left screens 25L and 26L, the right screens 25R and 26R, the upper screens 25U and 26U, and the lower screens 25D and 26D, respectively. The sub-images are displayed without correction of distortion. In addition, each sub-image is displayed so as to partially overlap the main image. In the example shown in FIGS. 5A and 5B, an object image T1a of a vehicle is displayed in the left image GL, and an object image T1b of the leading end of the vehicle is displayed in the main image GC. Also, an object image T2a of a portion of a pedestrian crossing is displayed in the lower image GD, and an object image T2b of the pedestrian crossing is displayed in the main image GC.

Next, the operation of the above-mentioned structure will be described. When the HMD 10 is worn and a power supply is turned on, the camera 15 starts to capture an image. The camera 15 captures a motion picture of the real space as a circular external video through the imaging lenses 15a, and each frame of the captured external video is sequentially transmitted to the image processing unit 22 through the signal processing unit 21.

In the image processing unit 22, the image dividing unit 31 extracts the main image, the left image, the right image, the upper image, and the lower image from the external video. In this case, each of the sub-images is extracted so as to partially overlap the main image. The extracted main image is transmitted to the distortion correcting unit 32, and each sub-image is transmitted to the LCD units 25 and 26. The distortion correcting unit 32 corrects the distortion of the imaging lens 15a in the input main image, and the main image without any aberration is transmitted to the image composition unit 33.

The information generating unit 23 detects, for example, the position or imaging direction of the camera unit 15 using a sensor provided therein. Then, the information generating unit 23 specifies, for example, a building or a road in the real space that is being currently captured by the camera unit 15 on the basis of the detection result, and generates the AR information thereof. Then, the AR information is transmitted to the image composition unit 33.

When the AR information is input to the image composition unit 33, the AR information is composed at a composition position on the main image based on the composition control information included in the AR information. When a plurality of AR information items are input, each of the AR information items is composed with the main image. Then, the main image having the AR information composed therewith is transmitted to the LCD units 25 and 26. The AR information may be composed with the sub-image.

The main image and each sub-image obtained in the above-mentioned way are transmitted to the LCD units 25 and 26 and, the main image is displayed on the main screens 25C and 26C. The left image and the right image are displayed on the left screens 25L and 26L and the right screens 25R and 26R arranged around the main screens 25C and 26C, respectively. In addition, the upper image is displayed on the upper screens 25U and 26U and the lower image is displayed on the lower screens 25D and 26D, respectively. In this way, for example, the wearer can observe the main image GC, the left image GL, the right image GR, the upper image GU, and the lower image GD shown in FIG. 5B through the ocular optical system.

The main image and each sub-image displayed on each screen are updated in synchronization with the image capture of the camera unit 15. Therefore, the wearer can observe the main image and each sub-image as a motion picture. When the wearer changes the viewing direction, the wearer can observe the main image and each sub-image which are changed with the change in the viewing direction.

The wearer can observe the real space in the viewing direction of the wearer using the distortion-corrected main image, and also can observe the AR information composed with the main image. Therefore, the wearer can move or work while observing the main image.

The left, right, upper, and lower images include a large amount of information regarding the real space in the horizontal and vertical directions of the wearer. As described above, the left, right, upper, and lower images are displayed without correction of distortion, but are sufficient for the wearer to sense things in the horizontal and vertical directions of the wearer in the real space. For example, the wearer can recognize an approaching vehicle early. In this case, since each sub-image is displayed such that a portion thereof overlaps the main image, it is easy for the wearer to grasp the relation between the object image in the sub-image and the object image in the main image.

### Second Embodiment

A second embodiment in which the display range of the real space by the main image is changed depending on the motion of the head of the wearer will be described below. Structures other than the following structure are the same as those in the first embodiment. Substantially the same components are denoted by the same reference numerals and a description thereof will be omitted.

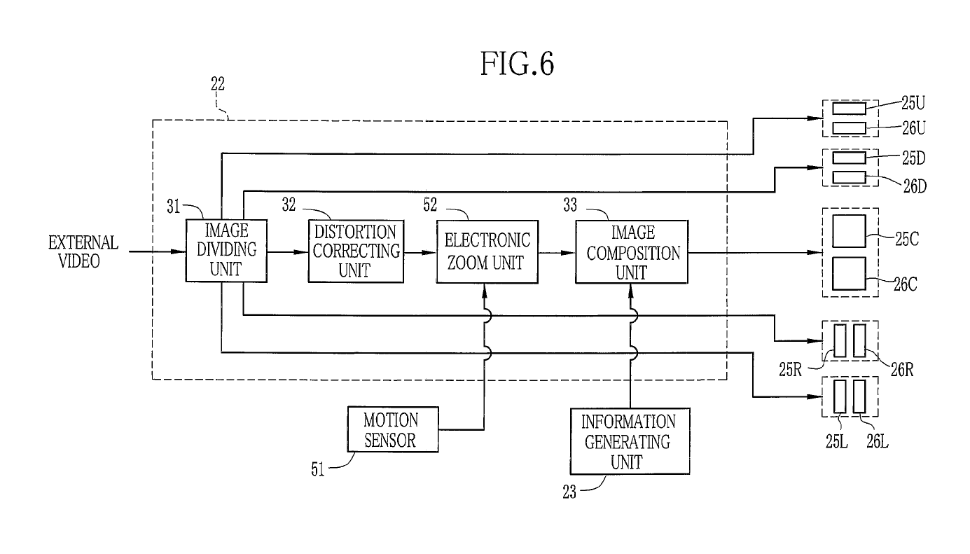

In this embodiment, as shown in FIG. 6, a motion sensor 51 and an electronic zoom unit 52 are provided. The motion sensor 51 is, for example, an acceleration sensor or an angular rate sensor, and detects the motion of the head of the wearer. In addition to the motion (for example, the rotation or linear motion) of the head of the wearer, the motion of the wearer accompanying the motion of the head is detected as the motion of the head.

The detection result of the motion sensor 51 is transmitted to the electronic zoom unit 52. The main image whose distortion has been corrected by the distortion correcting unit 32 is input to the electronic zoom unit 52. The electronic zoom unit 52 functions as a range adjusting unit, trims the main image to the range of a size corresponding to the detection result of the motion sensor 51, and enlarges the trimmed main image to the original size of the main image. In this way, the electronic zoom unit 52 adjusts the range of the real space displayed by the main image as if the imaging lens for capturing the main image is zoomed, and displays the main image on the main screens 25C and 26C. When the main image is trimmed, the center of the main image is not changed before and after trimming.

In this embodiment, there are a wide angle mode and a standard mode. The wide angle mode is for widely displaying the real space with the main image. In the wide angle mode, the electronic zoom unit 52 generates a main image corresponding to an angle of view of, for example, 80° using trimming and enlargement, and outputs the main image. In the standard mode, the real space is displayed with the main image at an angle of view smaller than that in the wide angle mode. In the standard mode, the electronic zoom unit 52 generates a main image corresponding to an angle of view of, for example, 50° using trimming and enlargement, and outputs the main image.

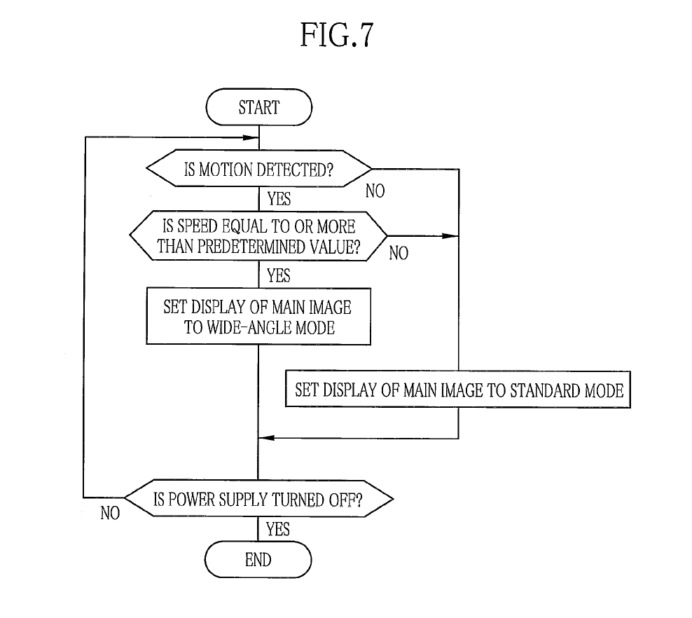

As shown in FIG. 7, the electronic zoom unit 52 sets the display mode to the wide angle mode when detecting that the head of the wearer is moving at a speed equal to or more than a predetermined value, for example, the normal walking speed of the wearer from the detection result of the motion sensor 51, and sets the display mode to the standard mode when detecting that the head of the wearer is moving at a speed less than the predetermined value.

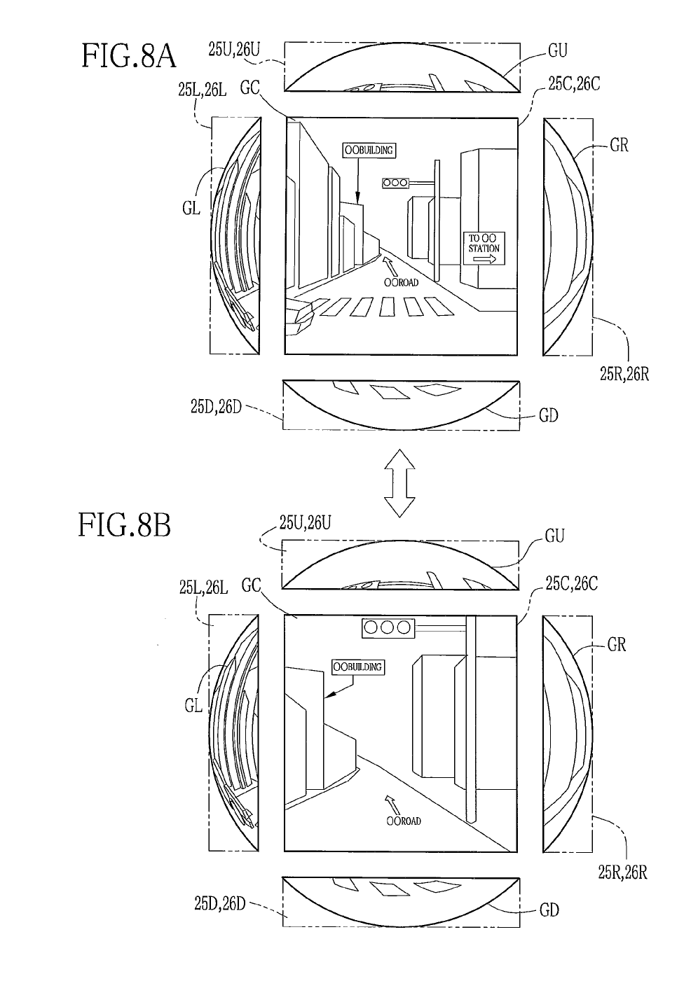

According to this embodiment, when the wearer walks at a speed equal to or more than the predetermined value, the display mode is changed to the wide angle mode. As shown in FIG. 8A, the main image GC set in a wide range of the external video is displayed on the main screens 25C and 26C, and the wearer can observe the real space in a sufficiently wide range for movement without any distortion.

In contrast, when the wearer walks slowly at a speed less than the predetermined value or is at a standstill, the display mode is changed to the standard mode. The main image GC set in a narrow range of the external video is displayed on the main screens 25C and 26C, and the wearer can gaze at, for example, a building in the real space.

In the above-described embodiment, the range of the real space displayed by the main image is adjusted according to whether the moving speed of the wearer is equal to or more than a predetermined value, but the present invention is not limited thereto. For example, the range of the real space maybe adjusted according to whether the wearer is moving. In addition, when the wearer has moved for a predetermined period of time or more and a predetermined period of time or more has elapsed from the stopping of the movement, the range of the real space displayed by the main image may be changed. When the range of the real space displayed by the main image is changed, the range may be gradually widened or narrowed.

In the above-described embodiment, when the range of the real space displayed by the main image is changed, the range of the real space displayed by each sub-image is not changed. However, the range of the real space displayed by each sub-image may be changed in correspondence with the main image. In this case, control may be performed such that the range of the real space displayed by the main image and the range of the real space displayed by each sub-image are changed in the same direction, that is, when the range of the real space displayed by the main image is narrowed, the range of the real space displayed by each sub-image is also narrowed. Alternatively, control may be performed such that the range of the real space displayed by the main image and the range of the real space displayed by each sub-image are changed in the opposite direction, that is, when the range of the real space displayed by the main image is narrowed, the range of the real space displayed by each sub-image is widened. When the former control is performed, a zoom imaging lens 15a may be used instead of the electronic zoom unit to change the focal length.

### Third Embodiment

A third embodiment in which the viewpoint position of the wearer is detected and the display range of the real space by the main image is changed on the basis of the detection result will be described below. Structures other than the following structure are the same as those in the first embodiment. Substantially the same components are denoted by the same reference numerals and a description thereof will be omitted.

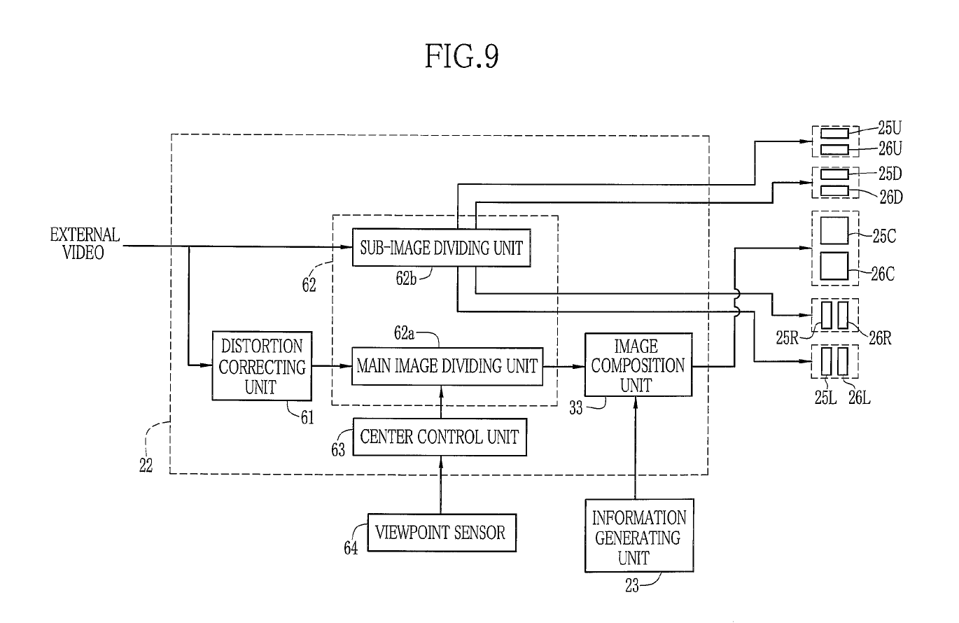

FIG. 9 shows the structure of an image processing unit 22 according to this embodiment. When an external video is input to the image processing unit 22, the external video is transmitted to a distortion correcting unit 61 and an image dividing unit 62. The distortion correcting unit 61 corrects the distortion of the imaging lens 15a, similarly to the distortion correcting unit 32 according to the first embodiment, but in this case, the distortion correcting unit 61 corrects the distortion of the entire input external video.

The image dividing unit 62 includes a main image dividing unit 62a and a sub-image dividing unit 62b. The main image dividing unit 62a extracts the main image from the external video using a position on the external video designated by a center control unit 63, which will be described below, as the center of the main image region C1. The sub-image dividing unit 62b extracts the left, right, upper, and lower peripheral portions of the input external video as a left image, a right image, an upper image, and a lower image, respectively. The main image is extracted from the distortion-corrected external video. However, the main image may be extracted from the external video before correction and then the distortion thereof may be corrected.

The main image extracted by the main image dividing unit 62a is transmitted to the main screens 25C and 26C through the image composition unit 33, and is then displayed thereon. The left image GL, the right image GR, the upper image GU, and the lower image GD extracted by the sub-image dividing unit 62b are transmitted to and displayed on the screens 25L, 26L, 25R, 26R, 25U, 26U, 25D, and 26D, respectively.

An HMD 10 includes a viewpoint sensor 64 that detects the viewpoint position of the wearer. The viewpoint sensor 64 includes, for example, an infrared ray emitting unit that emits infrared rays to an eyeball of the wearer and a camera that captures the image of the eyeball, and a viewpoint is detected by using a known corneal reflection method. The viewpoint may be detected by other methods.

The center control unit 63 determines the center position of the main image region C1 on the external video on the basis of the detection result of the viewpoint sensor 64, and designates the center position to the main image dividing unit 62a. The center control unit 63 calculates a gaze position on the external video at which the wearer is gazing from the viewpoint position of the wearer detected by the viewpoint sensor 64, and determines the center position of the main image region C1 such that the gaze position is at the center of the main image.

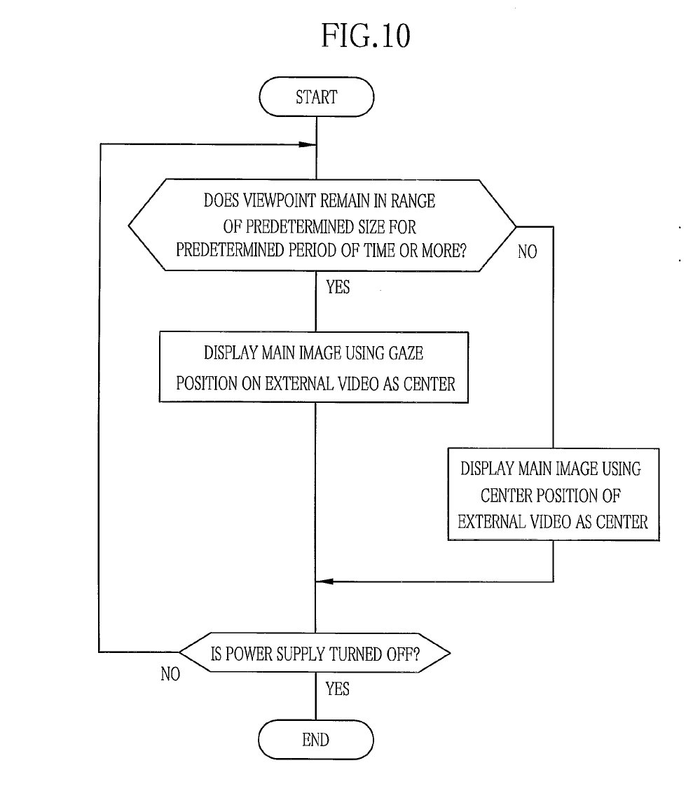

In this embodiment, as shown in FIG. 10, when the time for which the viewpoint is within the range with a predetermined size is equal to or more than a predetermined period of time, it is determined that the wearer is gazing at, for example, the center of the range as the gaze position. When it is determined that the wearer is gazing at the center of the range, the gaze position is designated to the main image dividing unit 62a. In this way, the main image having the gaze position as its center is displayed on the main screens 25C and 26C. When it is determined that the wearer is not gazing at the center of the range, the center of the external video is designated to the main image dividing unit 62a as the center position of the main image such that the wearer normally observes the real space.

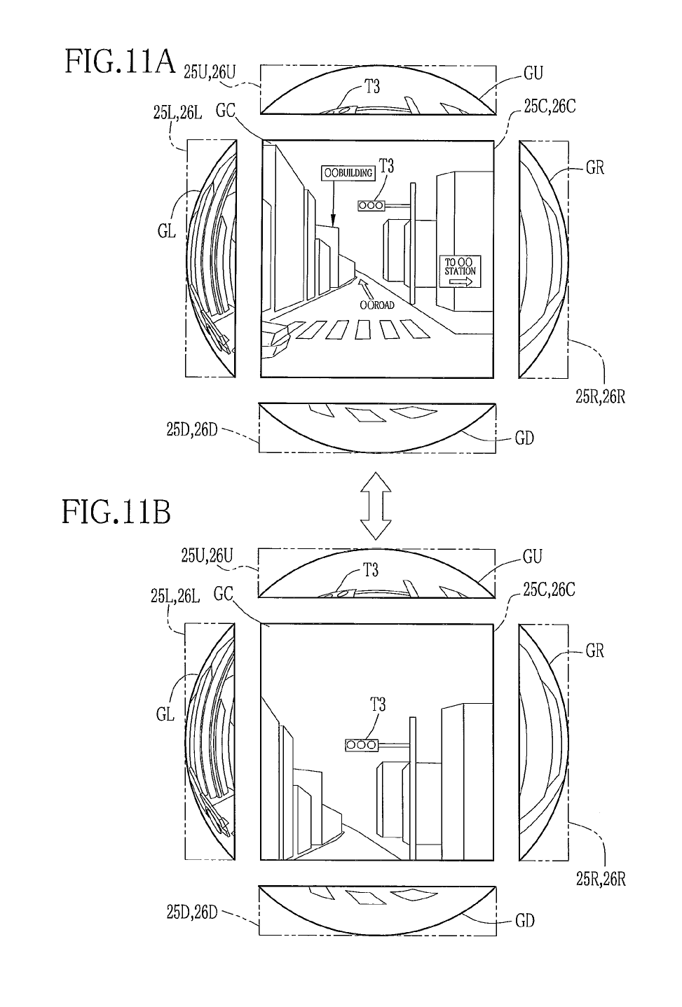

For example, in a case in which it is determined that the wearer is not gazing at the center of the range and the main image and each sub-image are displayed on the LCD units 18R and 18L as shown in FIG. 11A, when the wearer is gazing at an upper part of the main image GC or an object image T3 of a “signal lamp” displayed in the upper image GU, the display of the main image GC is changed such that the object image T3 of the “signal lamp” is at the center, as shown in FIG. 11B.

When the center position of the main image is moved on the external video, it is preferable to gradually move the center position of the main image to a target position and smoothly change the range of the main image on the external video displayed on the main screens 25C and 26C.

When the display range of the main image is moved, the display range of each sub-image is not changed. However, the range of the real space displayed by each sub-image may be moved in correspondence with the main image. In this case, an image around the main image may be extracted as the sub-image, and also the range of the sub-image may partially overlap the range of the main image. In addition, a mode in which the range of the main image is changed depending on gaze and a mode in which the range of the main image is fixed may be selected.

In the above-described embodiments, the sub-images are the left, right, upper, and lower images. However, the sub-images may be the left and right images or the upper and lower images.

What is claimed is:

1. A head-mounted display device that is worn on the head of a wearer and is used, comprising:
an imaging unit capturing an image of a real space as an external video through a wide-angle lens from a viewpoint substantially the same as that of the wearer;
an image dividing unit extracting a portion of the external video as a main image and extracting the external video around the main image or a peripheral image of the external video as a sub-image;
a distortion correcting unit correcting distortion of the wide-angle lens for the main image; and
a display unit displaying the main image in front of eyes of the wearer and displaying the sub-image around the main image.

2. The head-mounted display device according to claim 1, wherein the image dividing unit extracts the sub-image from the external video so as to overlap a portion of the main image.

3. The head-mounted display device according to claim 1, wherein
the image dividing unit extracts the sub-images from left and right sides of the main image, or from left and right peripheral portions of the external video, and
the display unit displays the corresponding sub-images on the left and right sides of the main image.

4. The head-mounted display device according to claim 1, wherein
the image dividing unit extracts the sub-images from upper, lower, left, and right sides of the main image, or from upper, lower, left, and right peripheral portions of the external video, and
the display unit displays the corresponding sub-images on the upper, lower, left, and right sides of the main image.

5. The head-mounted display device according to claim 1, wherein the image dividing unit extracts a central portion of the external video as the main image such that a center of the main image is aligned with a center of the external video captured by the imaging unit.

6. The head-mounted display device according to claim 1, wherein the imaging unit includes a circular fish-eye lens as the wide-angle lens.

7. The head-mounted display device according to claim 1, further comprising:
an additional information composition unit superimposing additional information on the main image or the sub-image to display the main image or the sub-image having the additional information superimposed thereon.

8. The head-mounted display device according to claim 1, further comprising:
a motion detecting unit detecting motion of a head of the wearer; and
a range adjusting unit changing a size of a range of the real space displayed by the main image on the basis of the detection result of the motion detecting unit.

9. The head-mounted display device according to claim 8, wherein when the motion detecting unit detects the motion, the range adjusting unit changes the range of the real space displayed by the main image to be wider than that when the motion detecting unit does not detect the motion.

10. The head-mounted display device according to claim 8, wherein when the speed of the motion detected by the motion detecting unit is equal to or more than a predetermined value, the range adjusting unit changes the range of the real space displayed by the main image to be wider than that when the speed of the motion is less than the predetermined value.

11. The head-mounted display device according to claim 8, wherein the image dividing unit extracts the sub-image from the external video so as to overlap a portion of the main image.

12. The head-mounted display device according to claim 8, wherein
the image dividing unit extracts the sub-images from left and right sides of the main image, or from left and right peripheral portions of the external video, and
the display unit displays the corresponding sub-images on the left and right sides of the main image.

13. The head-mounted display device according to claim 8, wherein
the image dividing unit extracts the sub-images from upper, lower, left, and right sides of the main image, or from upper, lower, left, and right peripheral portions of the external video, and
the display unit displays the corresponding sub-images on the upper, lower, left, and right sides of the main image.

14. The head-mounted display device according to claim 8, wherein the image dividing unit extracts a central portion of the external video as the main image such that a center of the main image is aligned with a center of the external video captured by the imaging unit.

15. The head-mounted display device according to claim 8, wherein the imaging unit includes a circular fish-eye lens as the wide-angle lens.

16. The head-mounted display device according to claim 8, further comprising:
an additional information composition unit superimposing additional information on the main image or the sub-image to display the main image or the sub-image having the additional information superimposed thereon.

17. The head-mounted display device according to claim 1, further comprising:
a viewpoint detecting unit detecting the viewpoint position of the wearer on the main image or the sub-image; and
a center control unit detecting a gaze position of the wearer on the external video on the basis of the detection result of the viewpoint detecting unit and controlling the image dividing unit to extract the main image having the detected gaze position as its center.

18. The head-mounted display device according to claim 17, wherein
the distortion correcting unit corrects the distortion of the wide-angle lens for the external video, and
the image dividing unit extracts the main image from the external video whose distortion is corrected by the distortion correcting unit.

19. The head-mounted display device according to claim 17, wherein the image dividing unit extracts the sub-image from the external video so as to overlap a portion of the main image.

20. The head-mounted display device according to claim 17, wherein
the image dividing unit extracts the sub-images from left and right sides of the main image, or from left and right peripheral portions of the external video, and
the display unit displays the corresponding sub-images on the left and right sides of the main image.

21. The head-mounted display device according to claim 17, wherein
the image dividing unit extracts the sub-images from upper, lower, left, and right sides of the main image, or from upper, lower, left, and right peripheral portions of the external video, and
the display unit displays the corresponding sub-images on the upper, lower, left, and right sides of the main image.

22. The head-mounted display device according to claim 17, wherein the imaging unit includes a circular fish-eye lens as the wide-angle lens.

23. The head-mounted display device according to claim 17, further comprising:
an additional information composition unit superimposing additional information on the main image or the sub-image to display the main image or the sub-image having the additional information superimposed thereon.
